(19) United States
(12) Patent Application Publication
(10) Pub. No.: US 2022/0408122 A1
(43) Pub. Date: Dec. 22, 2022

(54) LIVE EVENTS PLATFORM

(71) Applicant: APPLAUSE CREATORS, INC., Redondo Beach, CA (US)

(72) Inventors: Nitin KHANNA, Redondo Beach, CA (US); Matthew JAFFE, Redondo Beach, CA (US)

(73) Assignee: APPLAUSE CREATORS, INC., Redondo Beach, CA (US)

(21) Appl. No.: 17/843,260

(22) Filed: Jun. 17, 2022

Related U.S. Application Data
(60) Provisional application No. 63/212,489, filed on Jun. 18, 2021.

(51) Int. Cl. H04N 21/2187; H04N 21/24

(52) U.S. Cl. CPC H04N 21/2187; H04N 21/24

(57) ABSTRACT

A live events platform is provided for live performances or presentations in an online environment. Embodiments of the disclosure provide broadcasting a live event using a set of media services; collecting data related to the live event from the set of media services; interlaying the collected data from the set of media services collected using a plurality of separate data collection modalities into a converged representation of the live event using a single session model language to describe interactions with the converged representation of the event; and providing the converged representation of the event for user access with one or more client devices.

### CROSS-REFERENCE TO RELATED APPLICATIONS

This application claims the benefit of priority to U.S. Provisional Patent Application No. 63/212,489, filed Jun. 18, 2021, which is hereby incorporated by reference in its entirety.

### BACKGROUND

At live events, such as a lecture, concert, live show or the like, individuals performing or presenting to an audience are able to gain feedback on the performance from the audience in order to ascertain a reaction of the audience. For instance, during a concert, if the audience appreciates a particular song or performance, increased applause may occur. In this manner, the performers receive live feedback regarding how the audience is receiving the performance. The performer can use this feedback to increase certain activities known to please the audience. By pleasing the audience, the performer can drive further positive interaction with the audience with the hope of increasing audience interaction with the performer, such as increased album or other merchandise sales.

Currently, large amounts of real-time interaction between individuals occurs online via the internet. This interaction occurs via various modalities of on-line interaction. For instance, an inexhaustive list of modalities include live audio and/or video streaming, text chatting, picturing sharing, game streaming, and live polling. These modalities are provided via applications run by user devices interacting with servers or server systems providing the modality in the form of an interactive service. Typically, the various applications do not converge data across applications in a user-friendly manner.

Given the rich interactive applications provided over the internet, more and more presentations and performances are transitioning on line. However, because the various applications providing the on-line interactive modalities do not converge data, a rich, interactive, and holistic environment for these presentations and performances is currently unavailable.

### BRIEF SUMMARY

Aspects of the disclosure provide server system for hosting a live events platform, the server system comprising: one or more processors; and a memory storing instructions that when executed by the one or more processors configure the server system to perform steps comprising: broadcasting a live event using a set of media services; collecting data related to the live event from the set of media services; interlaying the collected data from the set of media services collected using a plurality of separate data collection modalities into a converged representation of the live event using a single session model language to describe interactions with the converged representation of the event; and providing the converged representation of the event for user access with one or more client devices.

Other aspects of the disclosure provide collecting user interactions with the live event platform based on the converged representation of the event; and analyzing the user interactions to determine one or more cues to prompt a performer of the live event with actions to perform during the live event based on the user interactions.

Other aspects of the disclosure provide analyzing the user interactions to produce enriched effects for users accessing the live event with one or more client devices.

In other aspects of the disclosure the enriched effects include adding reverb, echo, chorus, augmented-reality filters, and replacing of an audience member's live video with a virtual avatar.

Other aspects of the disclosure provide analyzing the user interactions to determine an effectiveness of the live event over the course of the live event to provide a timeline of user engagement over the course of the event; and determining preferred pricing, duration and schedules for future similar events based on the determined effectiveness.

Other aspects of the disclosure provide user interactions include interactions an audience member speaking with the artist live, reactions such as virtual hearts and claps, and tipping.

In other aspects of the disclosure provide the collected data includes metadata such as timestamp information and data marking a modality of collection.

Further aspects of the disclosure provide a method of broadcasting a live event using a set of media services; collecting data related to the live event from the set of media services; interlaying the collected data from the set of media services collected using a plurality of separate data collection modalities into a converged representation of the live event using a single session model language to describe interactions with the converged representation of the event; and providing the converged representation of the event for user access with one or more client devices.

Even further aspects of the disclosure provide a non-transitory computer-readable medium comprising instructions for hosting a live event over a live events platform, wherein when the instructions are executed by a computer, the computer is configured for: broadcasting a live event using a set of media services; collecting data related to the live event from the set of media services; interlaying the collected data from the set of media services collected using a plurality of separate data collection modalities into a converged representation of the live event using a single session model language to describe interactions with the converged representation of the event; and providing the converged representation of the event for user access with one or more client devices.

### BRIEF DESCRIPTION OF THE SEVERAL VIEWS OF THE DRAWING(S)

FIG. 1 illustrates a block diagram of a live events platform in accordance with an embodiment of the disclosure;

FIG. 2 illustrates a block diagram of a system of the live events platform for interlaying services capturing a live event in accordance with an embodiment of the disclosure;

FIG. 3 illustrates a session model language in accordance with an embodiment of the disclosure;

FIG. 4 illustrates an Artificial Intelligence (AI) and Machine Learning (ML) model in accordance with an embodiment of the disclosure;

FIG. 5 illustrates an exemplary interface of a live event broadcast from the perspective of the audience in accordance with an embodiment of the disclosure;

FIG. 6 illustrates an exemplary interface of a live event broadcast from the perspective of the performer in accordance with an embodiment of the disclosure;

FIG. 7 illustrates an exemplary mobile interface of a live event broadcast from the perspective of a host in accordance with an embodiment of the disclosure;

FIG. 8 illustrates an exemplary mobile interface of a live event broadcast from the perspective of a host in accordance with an embodiment of the disclosure;

FIG. 9 illustrates an exemplary mobile interface of a live event broadcast from the perspective of a host in accordance with an embodiment of the disclosure;

FIG. 10 illustrates an exemplary mobile interface of a live event broadcast from the perspective of the audience in accordance with an embodiment of the disclosure;

FIG. 11 illustrates a block diagram of a server system in accordance with an embodiment of the disclosure; and

FIG. 12 illustrates a hardware diagram of a server in accordance with an embodiment of the disclosure.

### DETAILED DESCRIPTION

Embodiments of the disclosure provided herein, provide an events platform for live performances or presentations in an online environment. Specifically, embodiments of the disclosure provide a user-friendly convergence of data from various online interactive modalities to create a rich and data holistic user environment that provides real-time interaction between presenters/performers and members of an audience. Embodiments of the disclosure further provide analytics regarding audience reaction and interaction with a presentation or performance. The analytics provide one or more of real-time data or post event data in order to generate feedback to a presenter or performer for improving or optimizing a presentation or performance. The analytics may further cause the events platform to provide information regarding the presentation or similar presentations or make offers for sale of merchandise to one or more members of the audience.

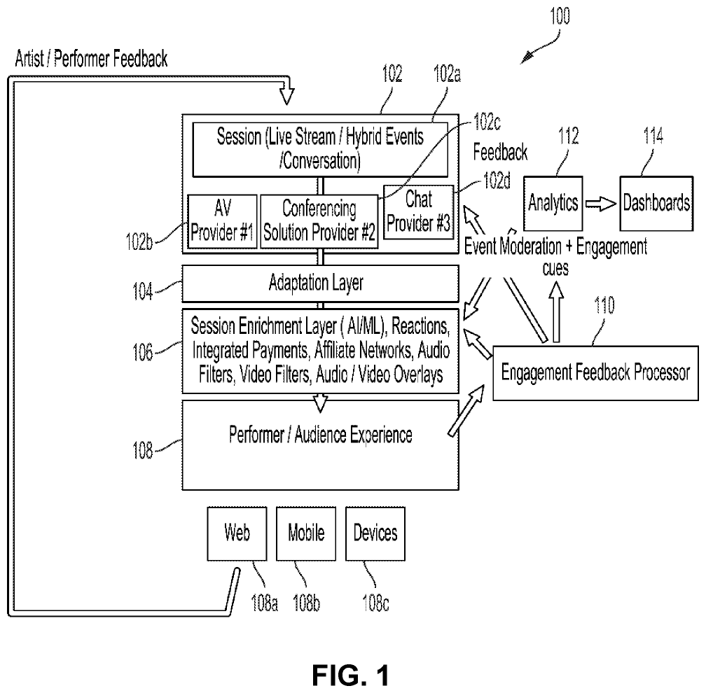

FIG. 1 illustrates a block diagram of a live events platform 100, in accordance with embodiments of the disclosure. The live events platform 100 includes a session layer 102, an adaptation layer 104, a session enrichment layer 106, and a performer/audience experience layer 108 that interacts with client devices 108a, 108b, and 108c. In addition, the live events platform 100 includes additional ancillary structure including an engagement feedback processor 110 that collects and processes audience feedback from the event, an analytics engine 112 that analyzes the event for providing cues to the audience or presenter/performer, and a user dashboard 114.

The session layer 102 represents a live event in the form of a session 102a. The session 102a includes the live presentation or performance and may be electronically captured via a variety of online modalities in the form of media services 102b, 102c, and 102d. The media services 102b, 102c, and 102d may include any form of interactive data collection/sharing regarding the session 102a such as audio and/or video streaming solutions, conferencing solutions, online chat providers, or any other such provider of interactive online services. A non-exhaustive list of providers of such services may include FACEBOOK, FACEBOOK LIVE, YOUTUBE, TWITCH, ZOOM, TWITTER and the like. In certain embodiments, the media services 102b, 102c, and 102d are not required to be the same for each session 102a hosted within the live events platform 100. Indeed, it is contemplated that the performer/presenter of the session 102a will have control over the various modalities of interaction captured using various combinations of one or more media services 102b, 102c, and 102d.

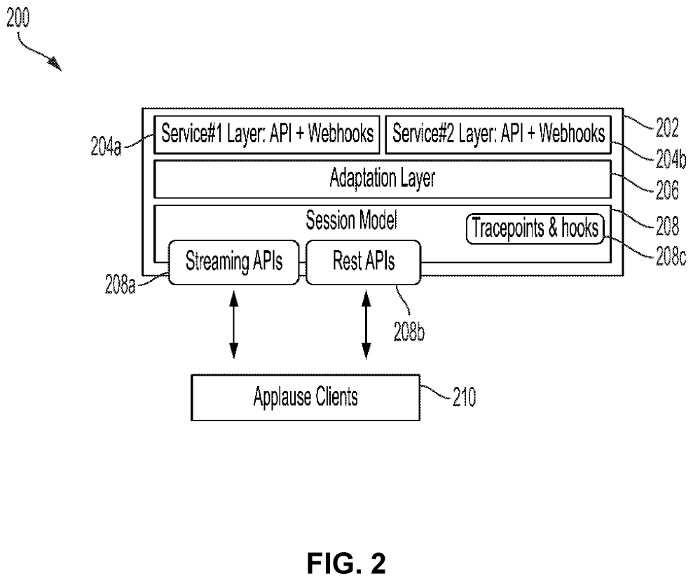

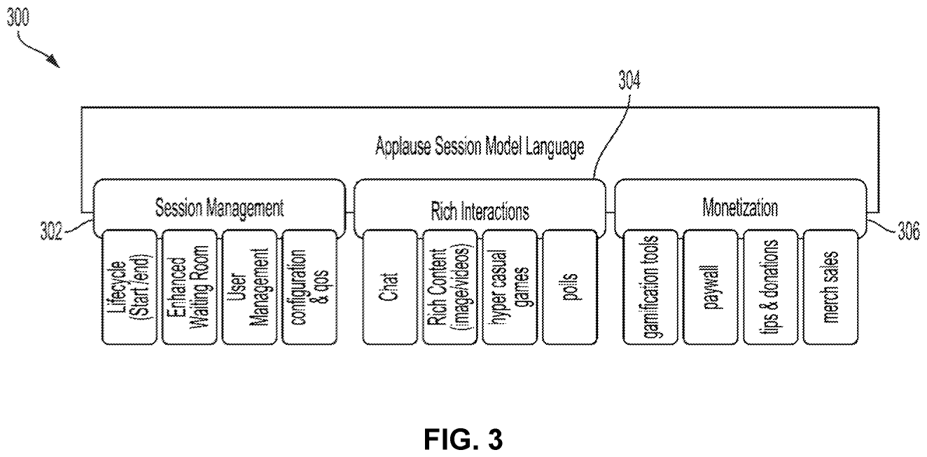

The adaptation layer 104 provides a deep integration with each provider of the services 102b, 102c, and 102d into an interlayed individual stream for the live events platform 100. The adaptation layer 104 collects data from each of the media services 102b, 102c, and 102d. Upon receiving new data from the media services 102b, 102c, and 102d, the adaptation layer 104 enables convergence of the received data onto a single media plane. To accomplish this goal, the adaptation layer 104 receives data regarding the session 102a from each of the media services 102b, 102c, and 102d where the data includes metadata such as timestamp information and data marking the modality (such as video, audio, chat, etc.). This enables a more holistic collection of data describing the session 102a in a collection of data from the media services 102b, 102c, and 102d interworked together based on the associated timestamp information. In this manner, a rich set of data is collected describing the session 102a in a more holistic fashion than any single media stream 102b, 102c, and 102d alone may be able to provide. Further details regarding this adaptation of services is provided below with respect to FIGS. 2 and 3.

The adaptation layer 104 also monitors various event notifications from the services 102b, 102c, and 102d to adapt delivery of the content from those services 102b, 102c, and 102d in a manner seamless to the user of the live events platform 100. In certain embodiments, the adaptation layer 104 has a hybrid architecture where part of the functionality exists with a server system hosting the live events platform 100 and additional functionality exists at an application running at client devices 108a, 108b, and 108c accessing the server hosting the live events platform 100. In this manner, the hybrid architecture allows for seamless integration of the services 102b, 102c, and 102d for a user of the live events platform 100.

The rich collection of data from the adaptation layer 104 is provided to the session enrichment layer 106 of the live events platform 100. The session enrichment layer 106 includes artificial intelligence and/or machine learning capabilities used to optimize the session 102a by adding on-demand, automated effects, and reactions to the session 102a. The session enrichment layer receives a variety of data regarding the session 102a in order to seed its artificial intelligence and machine learning algorithms to produce enriched effects, services, and feedback for the audience and the presenter/performer of the session 102a. In some embodiments, the effects can be both audio and visual in nature. Examples of audio effects include adding reverb, echo, and chorus. Visual effects include filters which enhance the color balance/saturation of video seen by audience members (like those in Instagram), augmented-reality filters that add digital elements to the live video (e.g. a digital hat or sunglasses) or, in the extreme, a complete replacement of the audience member (or artist's) live video with a virtual avatar.

For instance, the session enrichment layer 106 not only receives the rich collection of data from the adaptation layer 104 but also receives audience engagement and feedback from the engagement feedback processor 110 and various analytic information from the analytic engine 112. Accordingly, the session enrichment layer 106 is able to create real time feedback based on audience reaction to one or more aspects of the session 102a. In some embodiments, audience reactions may be determined by analyzing the video streams of audience members that choose to participate in the live event via video. The video streams from audience members are recorded as one of the inputs into the adaptation layer 104 while the event is in progress. Engagement feedback processor 110 processes the video stream to determine reactions of audience members during an event. In such embodiments, audience reactions may include facial reactions, eye focus, head movement. In some embodiments, AI/ML-tuned models that are part of engagement feedback processor 110 may be used to analyze the video streams to understand the audience member reactions to different portions of the live event, while the live event was in progress. In some embodiments, the video may be stored for processing after the live event as well.

In some embodiments, the audience members are notified that they are being recorded as soon as they join a live event. The audience member may chose to not have their video recorded. In some embodiments, the audience member may access the video stream that was recorded during the live event after the live event has ended. In such embodiments, the audience member may choose to delete their recorded video.

In this manner, the session enrichment layer is able to generate configuration parameters for the providers of the media services 102b, 102c, and 102d, cues for the presenter/performer, analytics regarding the session 102a, and tuning parameters and further information to provide to the audience.

The session enrichment layer 106 has static and non-static tools and methods that can add new experience elements to the user experience automatically or based on user actions. In some embodiments, user actions may include facial reactions, eye focus, and head movement of the audience members during the live event. The user actions may be determined from the video stream of audience members that are captured and analyzed by engagement feedback processor 110. These experience elements may be based on the modality provided by a specific service 102b, 102c, and 102d or may not be provided in the original modality but provided by the session enrichment layer 106. For instance, if the event is a concert, and we know that a song being played by the performer has always driven strong feedback from the audience in prior concerts and the audience is not responding currently, then the live events platform 100 can seed interactions to increase engagement with the song. A further example includes instances when a certain number of audience members are interacting with the live events platform 100 during a concert, virtual applause can be initiated. As the intensity of virtual applause increases the experience provided by the live events platform 100 automatically switches from broadcasting the performer to a community view with audience members being the focus. In this manner, the live events platform 100 can increase a community feel of the event. In these instances, further community interaction may be created by adding a “you are on camera” experience for a selected audience member(s) to be injected into the feed of the event. This drives an enriched experience and communal engagement with the live events platform 100. In some embodiments, the users may be prompted to engage with each other and artists.

Prompts that initiate user engagement include, but are not limited to, reminding users to create appreciation and donation streaks, highlighting who the top engagers/supporting are (thereby creating social pressure) or providing ways for audience members to easily request that an artist plays a song. Users may also be prompted to request an encore to the event, whereby an “encore” meter may be shown that measures fan and artist engagement and requires a certain threshold to be reached for the encore to be provided by the artist. In some embodiments, when a performance ends or a song ends but there is low or no user engagement, a small number of reactions (e.g. claps, hearts and GIFs) can be automatically sent by the system, thereby encouraging audience members to join in the appreciation of the performing artist. In some embodiments the artist may be prompted in the artist-side of the experience to remind them that they need to acknowledge top engaging/highest giving audience members.

An output of the session enrichment layer 106 is provided to the performer/audience experience layer 108. The performer/audience experience layer 108 provides the event media to an audience member of the event via a live events platform application running on client devices 108a, 108b, and 108c. The live events platform 100 is able to provide the event media over the application in accordance with the capabilities of each individual client devices 108a, 108b, and 108c. A non-exhaustive list of types of devices that are contemplated as client devices is a cell phone, a smart phone, a tablet, a computer, a laptop, a gaming system, a smart television, a streaming device, a smart speaker, and any such user device capable of running the live events application and allowing interaction from a user of the client device.

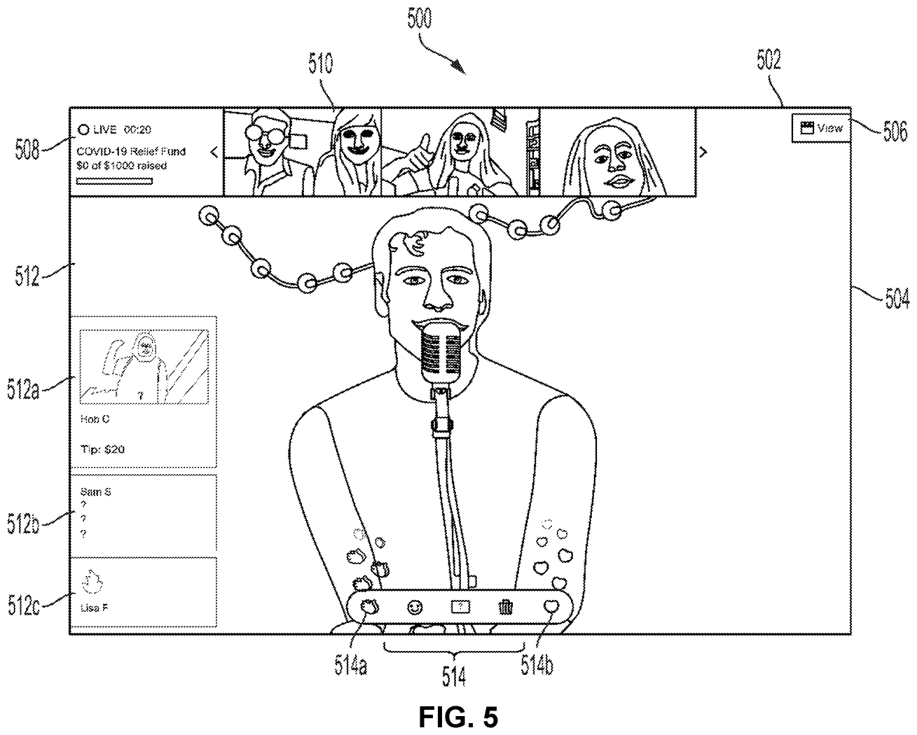

The performer/audience experience layer 108 is capable of providing separate views of the event based on capabilities of the client devices 108a, 108b, and 108c used to view the event. For instance, a view of the event for an audience member may include a variety of separate functionality meant to enable the interactive experience such as chat functionality, commenting functionality, like or dislike buttons to enable the audience member to express enjoyment or dissatisfaction with the event, payment options for tipping or paying for merchandise, and any other such interactive functionality based on the capabilities of the client devices 108a, 108b, and 108c. FIGS. 5-10 describe the various views of the event from the perspective of the audience member and the host/participant in detail.

Further, data generated by audience interaction at the client devices 108a, 108b, and 108c may be provided as feedback to the engagement feedback processor 110, which separates the data and creates cues for the presenter/performer to optimize the event, analytics for the event, tuning parameters for the session enrichment layer, and configuration parameters for providers of the various media services 102b, 102c, and 102d. The data generated from the audience interaction with the event provided to the engagement feedback processor 110 is further sent to the analytics engine 112 and in turn the dashboard 114.

In some embodiments, analytic information includes audience engagement, including, but not limited to, interactions (including an audience member speaking with the artist live) and reactions (sent such as virtual hearts and claps) and tipping. In some embodiments, interactions may include facial reactions, eye focus, and head movement of the audience members during the live event. The user actions may be determined from the video stream of audience members that are captured and analyzed by engagement feedback processor 110. In some embodiments, analytic information also includes time series metrics which indicate when the audience was most engaged (in terms of reactions or tips sent) or when they were paying the most attention (if we implemented eye tracking) to help artists optimize their events in the future (e.g. which songs or topics were most engaging). In some embodiments, analytic information may also highlight the most engaged audience members or biggest tippers for the artist to acknowledge them/give them a shout out. In some embodiments, analytic information may also include fan referral sources (i.e. where did fans discover the artist's event so that the artist knows where to focus their marketing efforts). In some embodiments, analytic information includes moments that were captured and shared on social media (i.e. which moments from an event are generating the most engagement outside of the platform, e.g. on social media).

The analytics engine 112 further analyzes the data to determine an effectiveness of the event over the course of the event to provide a timeline of user engagement over the course of the event so to understand what causes the most and least user engagement with the event. The analytics engine 112 further uses this data to determine preferred pricing, duration and schedules for future similar events. This data can then be correlated with other similar events so to make recommendations on content and presenter/performer lineup matching. This information can be displayed on the dashboard 114 for user engagement. In this manner, the dashboard 114 functions as a central console for the event from where the performer can monitor and control the event. The dashboard 114 allows the artist to push new modalities and content for the audience and also monitors how the audience responds to the content and event in real time via tools from the analytics engine 112, such as audience engagement and monetization. The dashboard 114 also allows the performer to preview content before it is pushed to the audience.

FIGS. 2-4 provide specific details of various aspects of the live events platform 100. FIG. 2 illustrates a block diagram 200 providing details regarding an interaction between providers of the media services 204a and 204b and the adaptation layer 206. In FIG. 2, the media services 204a and 204b are illustrated as Service #1 and Service #2, which each contain their own Application Programming Interface (API) and associated webhooks. As an aside, in the illustrated embodiment, the media services 204a and 204b only include two services. However, the use of Service #1 and Service #2 are only for ease of illustration in that embodiments of the disclosure contemplate any number of services.

Typically, Service #1 and Service #2 are provided by a third party online media streaming service such as FACEBOOK, FACEBOOK LIVE, YOUTUBE, TWITCH, ZOOM, TWITTER and the like. These services each provide an API that enables outside interaction with an online environment provided by the service. The services also provide webhooks that allow user defined callbacks triggered by some event occurring within the platform offered by the service. Using these features, the adaptation layer 206 interacts with Service #1 and Service #2 to interlay the services into a common session model using a common session model language. Specifically, the adaptation layer 206 utilizes the API for each of Service #1 and Service #2 to create a common session model 208 of the event such that user interactions with Service #1 and Service #2 during a live event can be captured and understood collectively within the live events platform 100 (see FIG. 1). The webhooks of each of Service #1 and Service #2 function as a callback to the Service #1 and Service #2 when a user of the live events platform 100 interacts via the session model 208. The callback is created to the Service #1 or Service #2 that the interaction has occurred.

The session model 208 is a service independent model environment that wraps the underlying services provided by Service #1 and Service #2 into a single underlying session. The session model 208 includes tracepoints and hooks 208c that serve to integrate functionality of Service #1 and Service #2 into the session model 208. The session model 208 further includes Streaming APIs 208a and Representational State Transfer (REST) APIs 208b that collectively act as a communication interface for client devices 108a, 108b, and 108c used to access the live events platform 100 (see FIG. 1) during an event hosted by the live events platform 100. In this manner, client devices 108a, 108b, and 108c can access the session model 208 to view and interact with the event.

The Streaming APIs 208a function to stream data associated with the event to/from the client devices 210. In this regard, the client devices 210 attach to the streaming APIs 208a when participating as an audience member of the event hosted by the live event platform 100. The streaming APIs 208a then convey data in real-time between the client devices 210 and the session model 208 for the event. The REST APIs 208b cooperate with the streaming APIs 208a in order to deliver the user experience of the event.

The communication interface between the session model 208 and the client devices 210 illustrated as the streaming APIs 208a and the REST APIs 208b in the illustrated embodiment of FIG. 2 communicate using an open and asynchronous API compliant specification session model language. FIG. 3 illustrates this session model language 300. In the illustrated embodiment, the session model language 300 enables a comprehensive event experience by providing a comprehensive set of independent APIs associated with the various services, such as Service #1 and Service #2 illustrated in FIG. 2. The session model language 302 enables a uniform method of communication within the live event platform 100 (see FIG. 1) to enable interlay of functionality between the various services used to capture the event in a seamless fashion.

In the illustrated embodiment, session model language 300 includes three broad categories of the language. Specifically, these categories include Session Management 302, Rich Interactions 304, and Monetization 306. The Session Management 302 category defines data regarding management of the session such as a lifecycle including a start and stop time of the event. It also includes data associated with an enhanced waiting room such that audience members can access particularized event information on a client device 108a, 108b, and 108c while waiting for the event to begin (see FIG. 1). The Session Management 302 category of the session model language 300 further includes user management data, which is used to control how users join an event on the live events platform 100. The user management data further aides in crowd control for the audience during the event. For example, given the universal modeling layer of the session model language 300, the live events platform 100 works in the background to configure and manage users on the platform in order to flag inappropriate content and users and remove them from the audience as needed. The Session Management 302 category also includes configuration and Quality of Service (QoS) data for the session model language 300. Configuration and QoS data defines a user experience that is unique to a client device 108a, 108b, and 108c based on the capabilities of the client device and the communication channel used to access the live events platform 100 (see FIG. 1) over the internet.

The Rich Interactions 304 include user interactions defined by the session model language for the session model 208 based on the interlayed services, such as Service #1 and Service #2 (see FIG. 2). A non-comprehensive list of functionality is illustrated in FIG. 3 to include chat interaction, rich content such as images and videos, hyper casual game content, and polls. The chat functionality provides an ability of various audience members and/or the presenter/performer of the event to interact via a chat service. The rich content allows for the insertion of an image or video into the event using the session model language. The hyper casual games provide simple gaming functionality associated with the event for play by audience members accessing the event over a client device 108a, 108b, and 108c (see. FIGS. 1 and 2). The poll provides functionality from a polling service that enables the live event platform 100 to conduct a poll among audience members for the event.

The Monetization 306 category of the session model language 300 allows for defining aspects of the live events platform 100 (see FIG. 1) to monetize the event. For instance, this may include gamification tools used to create game like aspects of typical interaction with the live event platform 100. The monetization 306 category may also include a paywall that blocks client devices 108a, 108b, and 108c that are not authorized to access the event from accessing the complete event. For example, in certain embodiments, the event waiting room may be open for any client device 108a, 108b, and 108c to access; however, only client devices 108a, 108b, and 108c where a user of that device has paid a fee for accessing the event is allowed past the waiting room to view and interact within the event. The Monetization 306 category may further include functionality for tipping or donating to a presenter/performer and for offering merchandise sales opportunities to the audience from the presenter/performer. All of these monetization aspects may further be driven by analysis of data regarding engagement of the audience with the event.

Using the above described categories of the session model language 300, interactive data between the presenter/performer of the event and the audience can be defined captured and analyzed in order to improve a user experience of the live events platform 100 (see FIG. 1). This analysis and improvement of the user experience is aided by the session enrichment layer 106, which, as described above, hosts Artificial Intelligence (AI) and Machine Learning (ML) functionality to analyze the collected data and to make recommendations to users of the live event platform 100.

In some embodiments, recommendations may be made for pricing and ticketing tiers based on artist genre, audience size, and engagement in their past events when an event is created. In some embodiments, the analytic information may detect songs performed by the artist that see the highest user attention/engagement and then present this information to the artist (either before or during the event) for them to better understand their performance and how to optimize current and future performances (e.g. which songs to play in the future, which topics to talk about, etc. for higher engagement/tips).

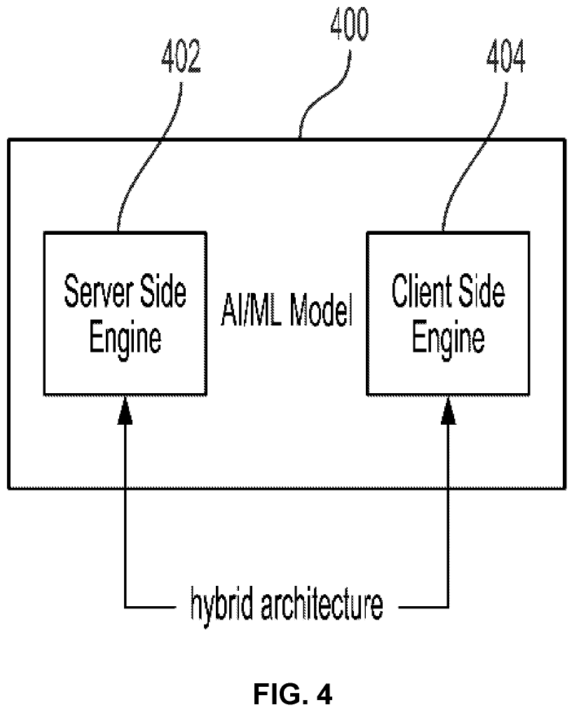

FIG. 4 illustrates an AI/ML model 400 that is implemented as part of the session enrichment layer 106 (see FIG. 1) operating in conjunction with the engagement feedback processor 110 and analytics engine 112 to optimize the user experience. In the illustrated embodiment, the AI/ML model 400 is a hybrid architecture that includes a server side engine 402 and a client side engine 404. The server side engine 402 executes aspects of the AI/ML model 400 at a server hosting the live events platform 100. The client side engine 404 executes aspects of the AI/ML model 400 at the client devices 108a, 108b, and 108c. In this embodiment, the client side engine 404 runs aspects of the AI/ML model 400 of particular use by the client devices 108a, 108b, and 108c. In this manner, functionality of the AI/ML model 400 pertinent to the client devices 108a, 108b, and 108c is offloaded to the client side engine 404 to ease computational resources at the server side engine 402. In other embodiments of the live events platform 100, only a server side engine 402 provides the AI/ML model 400. In these embodiments, the server side engine 402 provides all AI/ML model 400 functionality for both the server side and the client device side.

The AI/ML model 400 operates by taking input data points regarding an event hosted by the live events platform 100 (see FIG. 1) in order to generate cues for users of the live events platform 100 (such as the presenter/performer or audience members), analytics for the event, and configuration parameters for the services, such as Service #1 and Service #2 from FIG. 2. A non-exhaustive list of input data for the AI/ML model 400 includes event metadata, captured feedback data regarding the event, current experience data regarding the event, audience attention engagement data, and quality of audio and video streams for the event.

Event metadata includes information such as the type of presentation or performance in the event and any other data broadly defining the type of event. Feedback regarding the event may include contemporaneous data from the live event or data from prior versions of the event previously provided over the live events platform 100. In either situation, the feedback data may include information such as audience engagement with various aspects of the presentation or performance at various times throughout the prior event. Data regarding the current experience may include information regarding particular aspects of the event, such as a particular song being performed in the event is a concert. Audience attention engagement data defines how engaged the audience is with the presentation or performance at any given moment. This engagement may be captured in a variety of manners. For instance, the data could be based on how the audience member is interacting with the live events platform 100 at any particular moment, such as actively chatting with others during the performance or presentation, indicating appreciation for the presentation or performance by using “Like” buttons and the like, or any other manner of live interaction with the live events platform 100. Data regarding a quality of the audio and/or video may include data rates for the connection of the client devices, packet loss rates, and any other internet service quality metrics useful for determining a quality of a connection between a server and a client device interacting with the server.

Using the above discussed inputs to the AI/ML model 400, various actions can be taken by the live events platform 100 (see FIG. 1) to optimize the event. For instance, cues for both presenters/performers and audience members can be generated. An example of a cue for presenters/performers may be to provide an indication to acknowledge one or more audience members based on a tip or donation provided by that audience member. Further cues for presenters/performers may include a cue to signal that the presenter/performer should take a break generated based on a variety of inputs such as audience attention engagement, current experience data, and past feedback data on the event. Presenter/performer cues also include indications on actions to take during a presentation/performance to increase audience satisfaction, such as playing a particular song at a particular time during a concert in order to optimize audience reaction and engagement with the performance.

The AI/ML model 400 may also generate audience cues. For example, a cue to audience members may be provided over one of more client devices 108a, 108b, and 108c (see FIG. 1) requesting the audience member demonstrate appreciation for the presenter/performer. This cue could be based on a particular attention engagement of that audience member, and the cue could be in the form of asking for a tip or donation or purchasing merchandise from the presenter/performer through the live events platform 100. Further audience cues include indications to adjust audio and/or video parameters at the client devices 108a, 108b, and 108c to optimize the streaming experience. Additionally, cues can be provided to audience members to seed interactions with the live events platform 100. For example, if a particular audience member has a high engagement with the event, the AI/ML model 400 could provide a cue recommending other similar events hosted on the live events platform 100 in the future for the audience member to consider attending.

FIG. 5 illustrates an exemplary interface 500 of a live event broadcast from the perspective of an audience member accessing the live event on client devices 108a, 108b, and 108c. The client devices 108a, 108b, and 108c may be mobile devices, web applications, and computer devices. FIG. 5 shows a screen view 502 of the interface 500 of a live event broadcast. Screen view 502 includes an area 504 where the performer is displayed and an audience view section 510 where the audience members are displayed. Screen view 502 also includes an information box 508 and a live update panel 512. In some embodiments, an audience member watching the live event on screen view 502 may change the arrangement of the different portions of the screen listed above by pressing button 506. Some exemplary views of the screen view 502 may include rearranging the audience view section 510, live update panel 512, and information box 508. In some embodiments, one or more of areas of screen view 502 may be hidden from immediate view. In some embodiments, the audience view section 510 shows the video of audience members that have also turned their video on. In some embodiments, the information box 508 shows the information related to the event that is being broadcast. In such embodiments, the information box 508 may show the name of the performer in area 504, the time remaining in the event, and the time elapsed since the event started, and any fundraising goals of the event.

Live update panel 512 depicts a panel with continuous stream of updates coming in from other audience members watching the live stream. Update 512a depicts that a different audience member donated to the cause. Update 512b and 512c show reactions from other audience members. At the bottom of screen view 502, there are controls 514 that may allow the audience member watching the live event to participate in the live event. For example, buttons 514a and 514b are reaction buttons that may inform the other audience members and the performer of the feelings of the audience member. Additionally, there are other buttons in controls 514 that allow the audience members to participate in the live event in other ways. In some embodiments, there may be a donate button for the audience members to donate for charitable causes associated with the live event. In some embodiments, the audience members may choose to participate in the event using their video. In such embodiments, the video streams from audience members are recorded while the event is in progress. The recorded video may be processed in real time to determine reactions of audience members during an event. In such embodiments, audience reactions may include facial reactions, eye focus, and/or head movement, etc. In some embodiments, the recorded video stream may be analyzed after the live event for information for future events.

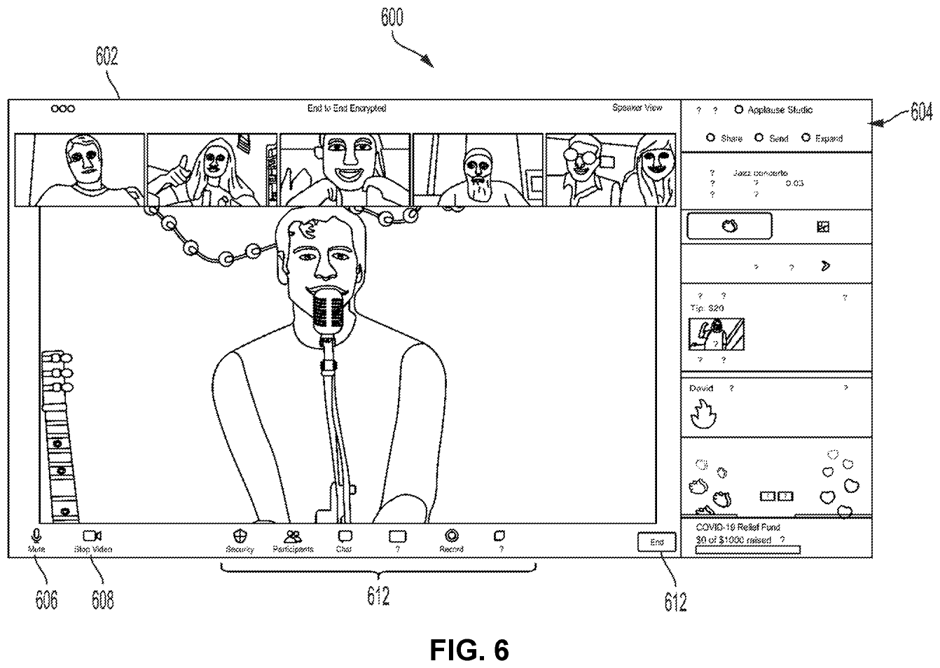

FIG. 6 illustrates an exemplary interface 600 of a live event broadcast from the perspective of the performer. FIG. 6 shows a screen view 602 of the interface 600 of a live event broadcast. Screen view 602 is similar to screen view 502 (see FIG. 5), except that screen view 602 includes additional buttons 606, 608, 610, and 612. Button 606 mutes or unmutes the performer. Button 608 may start or stop the video of the performer. Buttons 610 include control buttons such as screen share, participant list, record, chat, etc. Button 612 allows the performer to end the event by pressing the end button. Information panel 604 displays the information regarding the event to the performer. In some embodiments, the information panel 604 allows a performer to share the event to other platforms, send the event to audience members, or expand display window of the information panel 604.

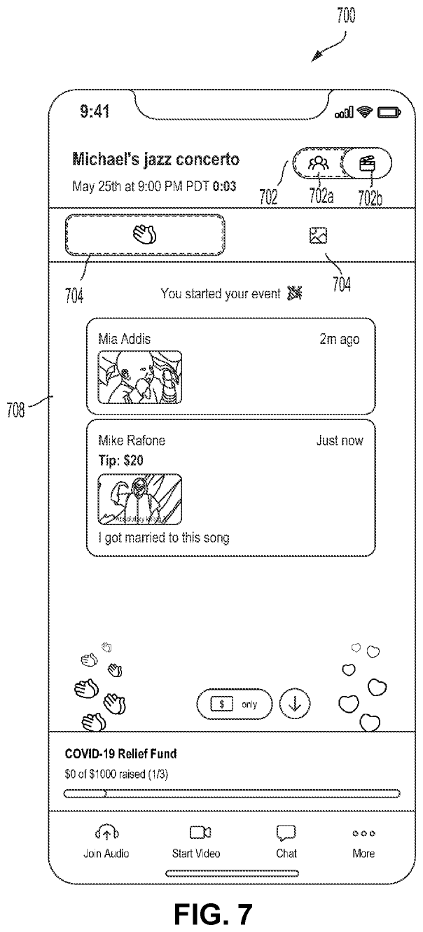

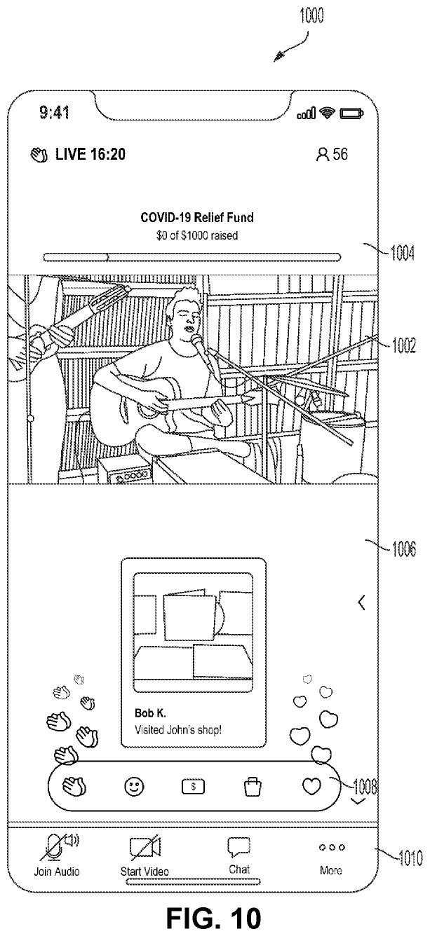

FIGS. 7-10 illustrate an exemplary mobile interface of a live event broadcast in accordance with an embodiment of the disclosure. In particular, FIGS. 7-9 illustrate an exemplary mobile interface of a live event broadcast from the perspective of a host and FIG. 10 illustrates an exemplary mobile interface of a live event from the perspective of the audience. In some embodiments, the mobile interface of the application may be accessed from mobile devices such as smartphones, tablets, and portable computers.

FIG. 7 illustrates an exemplary mobile interface of a live event cast from the perspective of the host in accordance with an embodiment of the disclosure. In some embodiments, when using a mobile application to host or co-host an event, a host may use two “modes” of operation of the mobile application interface 700. Button 702 depicts a toggle button at the top right corner of the screen that allows a host to switch between the two modes of operation. Toggle button 702 may be used to toggle between audience mode 702a and producer mode 702b. In some embodiments, in producer mode, the host has two different possible views. These views are selectable from reactions tab 704 and media tab 706. Reactions tab 704 allows the host to see a stream of interactions from audience members that are sharing their interactions in the interface while watching the event. In some embodiments, the reactions of the various audience members watching the event may be collated in portion 708 of the mobile application interface 700.

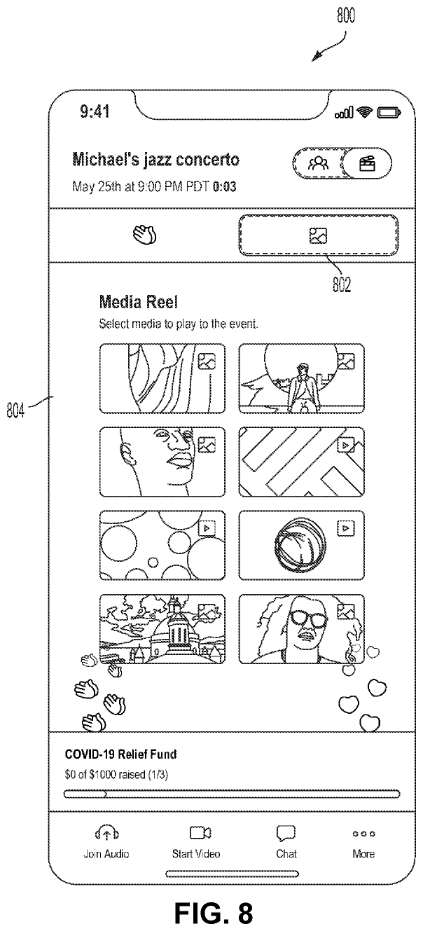

FIG. 8 illustrates an exemplary mobile interface of a live event broadcast from the perspective of the host in accordance with an embodiment of the disclosure. FIG. 8 differs from FIG. 7 because FIG. 8 shows the view of media tab 802 instead of reactions tab 704 (see FIG. 7). Media tab 802 allows a host to see all the media that the host or the audience members may have shared in the interface during the event. In some embodiments, the media collected during the event may be displayed in portion 804 of the mobile application interface 800. In some embodiments, the media tab 802 allows the host to access media stored on their mobile device to display to the audience. In some other embodiments, the media tab 802 allows the host to access data stored in remote online databases to display to the audience. In such embodiments, the media to be displayed in portion 804 of the mobile application interface 800 may include media such as high quality video, audio or pictures) to show to the audience participating in the event.

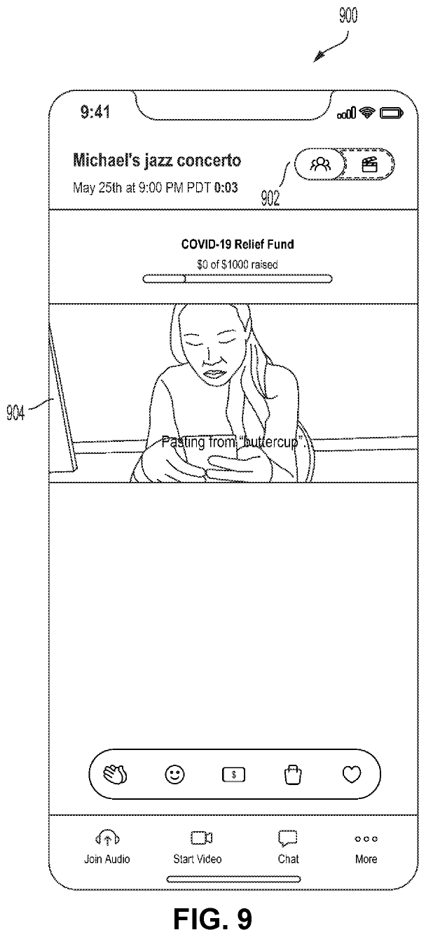

FIG. 9 illustrates an exemplary mobile interface of a live event broadcast from the perspective of the host in accordance with an embodiment of the disclosure. Mobile application interface 900 depicts operation of the mobile application in “audience” mode instead of producer mode. In some embodiments, the audience mode may be selected by selecting the audience mode on toggle button 902. In such embodiments, in “audience mode,” the host is able to experience the event as an audience member. Interfaces related to the experience of the audience member are described in more detail in FIG. 5 and FIG. 10. FIG. 10 illustrates an exemplary mobile interface of a live event from the perspective of the audience in accordance with an embodiment of the disclosure. FIG. 10 shows a screen view 1000 of the mobile application interface of a live event. Screen view 1000 includes an area 1002. Screen view 1000 also includes an information box 1004 and a live update panel 1006. In some embodiments, the user watching the live event on screen view 100 may change the arrangement of the different portions of the screen. Some exemplary views of the screen view 1000 may include rearranging information box 1002, live update panel 1006, and area 1002. In some embodiments, in some views, one or more of areas of screen view 502 may be hidden from immediate view.

Live update panel 1006 depicts a panel with continuous stream of updates coming in from other audience members watching the live stream. Additionally, buttons in controls 1008 allow the audience members to participate in the live event in other ways. In some embodiments, there may be a donate button for the audience members to donate money, such as donating money to the performer and/or to donate money for charitable causes associated with the live event. In some other embodiments, there may be reaction buttons that allow an audience member to send their reactions to the event to the host/performer. Controls 1010 allow a user to participate in the event using their mobile device input devices such as microphone, camera, and keyboard. In some embodiments, a performer may allow audience members to provide audio or video feedback to their performance. In some other embodiments, the chat feature allows different audience members to communicate with each other during the event.

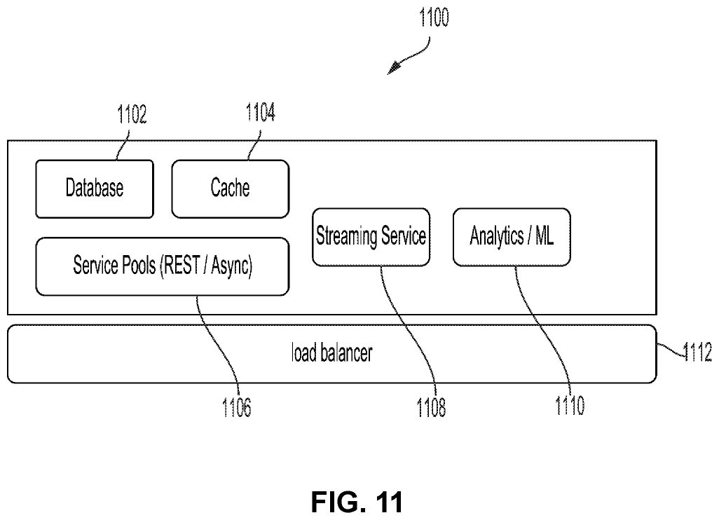

FIG. 11 illustrates a functional block diagram architecture for a server system 1100 configured for hosting the live events platform 100 (see FIG. 1) in a cloud environment. While the server system 1100 illustrates only a single server, it is contemplated that the server system 1100 may include multiple physical servers working together to host the live events platform.

As illustrated, the server system 1100 includes a database 1102 that stores data associated with the live events platform 1000 (see FIG. 1). The data base 1102 may store data associated with events provided over the live events platform along with data associated with users of the live events platform 100. Cache 1104 functions as temporary storage for the live events database 100 that enables efficient processing of tasks associated with the live events platform 100. The service pools 1106 and streaming service 1108 provide the streaming APIs 208a and REST APIs 208b (see FIG. 2) used as a communications interface between the server system 1100 and client devices 108a, 108b, and 108c. The analytics/ML engine 1110 is specialized functionality within the server system 1100 for providing machine-learning analytics. This functionality is configured for providing the AI/ML model 400 (see FIG. 4). The server system 1100 further includes a load balancer 1112, which enables multiple computing nodes within the server system 1100 to efficiently distribute network and/or application traffic across multiple servers in the server system 1100.

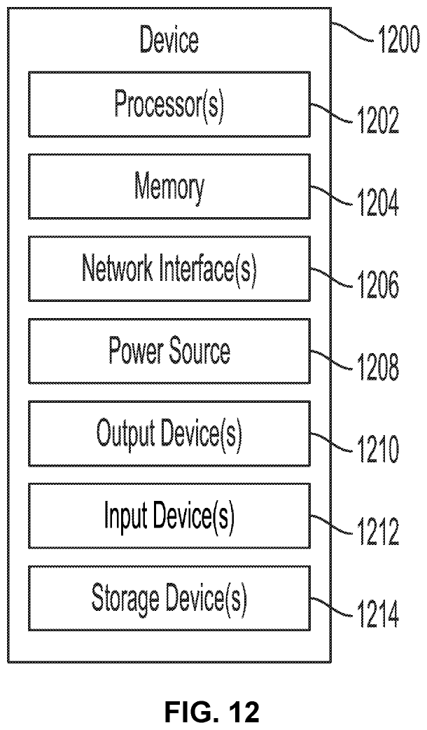

FIG. 12 illustrates an electronic device 1200 according to an embodiment of the disclosure. Electronic device 1200 describes hardware components of a typical server device configured for hosting the live events platform 100 (see FIG. 1), such as a server from server system 1100 (see FIG. 11). The device 1200 may include one or more processors 1202, memory 1204, network interfaces 1206, power source 1208, output devices 1210, input devices 1212, and storage devices 1214. Although not explicitly shown in FIG. 12, each component provided is interconnected physically, communicatively, and/or operatively for inter-component communications in order to realize functionality ascribed to the various entities identified in FIG. 1. To simplify the discussion, the singular form will be used for all components identified in FIG. 12 when appropriate, but the use of the singular does not limit the discussion to only one of each component. For example, multiple processors may implement functionality attributed to processor 1202.

Processor 1202 is configured to implement functions and/or process instructions for execution within device 1200. For example, processor 1202 executes instructions stored in memory 1204 or instructions stored on a storage device 1214. In certain embodiments, instructions stored on storage device 1214 are transferred to memory 1204 for execution at processor 1202. Memory 1204, which may be a non-transient, computer-readable storage medium, is configured to store information within device 1200 during operation. In some embodiments, memory 1204 includes a temporary memory that does not retain information stored when the device 1200 is turned off. Examples of such temporary memory include volatile memories such as random access memories (RAM), dynamic random access memories (DRAM), and static random access memories (SRAM). Memory 1204 also maintains program instructions for execution by the processor 1202 and serves as a conduit for other storage devices (internal or external) coupled to device 1200 to gain access to processor 1202.

Storage device 1214 includes one or more non-transient computer-readable storage media. Storage device 1214 is provided to store larger amounts of information than memory 1204, and in some instances, configured for long-term storage of information. In some embodiments, the storage device 1214 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

Network interfaces 1206 are used to communicate with external devices and/or servers. The device 1200 may comprise multiple network interfaces 1206 to facilitate communication via multiple types of networks. Network interfaces 1206 may comprise network interface cards, such as Ethernet cards, optical transceivers, radio frequency transceivers, or any other type of device that can send and receive information.

Power source 1208 provides power to device 1200. For example, device 1200 may be battery powered through rechargeable or non-rechargeable batteries utilizing nickel-cadmium or other suitable material. Power source 1208 may include a regulator for regulating power from the power grid in the case of a device plugged into a wall outlet, and in some devices, power source 1208 may utilize energy scavenging of ubiquitous radio frequency (RF) signals to provide power to device 1200.

Device 1200 may also be equipped with one or more output devices 1210. Output device 1210 is configured to provide output to a user using tactile, audio, and/or video information. Examples of output device 1210 may include a display (cathode ray tube (CRT) display, liquid crystal display (LCD) display, LCD/light emitting diode (LED) display, organic LED display, etc.), a sound card, a video graphics adapter card, speakers, magnetics, or any other type of device that may generate an output intelligible to a user.

Device 1200 is equipped with one or more input devices 1212. Input devices 1212 are configured to receive input from a user or the environment where device 1200 resides. In certain instances, input devices 1212 include devices that provide interaction with the environment through tactile, audio, and/or video feedback. These may include a presence-sensitive screen or a touch-sensitive screen, a mouse, a keyboard, a video camera, microphone, a voice responsive system, or any other type of input device.

The hardware components described thus far for device 1200 are functionally and communicatively coupled to achieve certain behaviors. In some embodiments, these behaviors are controlled by software running on an operating system of device 1200.

All references, including publications, patent applications, and patents, cited herein are hereby incorporated by reference to the same extent as if each reference were individually and specifically indicated to be incorporated by reference and were set forth in its entirety herein

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A server system for hosting a live events platform, the server system comprising:
one or more processors; and
a memory storing instructions that when executed by the one or more processors configure the server system to perform steps comprising:
broadcasting a live event using a set of media services;
collecting data related to the live event from the set of media services;
interlaying the collected data from the set of media services collected using a plurality of separate data collection modalities into a converged representation of the live event using a single session model language to describe interactions with the converged representation of the event; and
providing the converged representation of the event for user access with one or more client devices.

2. The server system of claim 1, wherein the instructions further configure the server system to perform steps further comprising:
collecting user interactions with the live event platform based on the converged representation of the event; and
analyzing the user interactions to determine one or more cues to prompt a performer of the live event with actions to perform during the live event based on the user interactions.

3. The server system of claim 2, wherein the instructions further configure the server system to perform steps further comprising:
analyzing the user interactions to produce enriched effects for users accessing the live event with one or more client devices.

4. The server system of claim 3, wherein the enriched effects include adding reverb, echo, chorus, augmented-reality filters, and replacing of an audience member's live video with a virtual avatar.

5. The server system of claim 4, wherein the instructions further configure the server system to perform steps further comprising:
analyzing the user interactions to determine an effectiveness of the live event over the course of the live event to provide a timeline of user engagement over the course of the event; and
determining preferred pricing, duration and schedules for future similar events based on the determined effectiveness.

6. The server system of claim 5, wherein user interactions include interactions an audience member speaking with the artist live, reactions such as virtual hearts and claps, and tipping.

7. The server system of claim 1, wherein the collected data includes metadata such as timestamp information and data marking a modality of collection.

8. A method of hosting a live event over a live events platform, the method comprising:
broadcasting a live event using a set of media services;
collecting data related to the live event from the set of media services;
interlaying the collected data from the set of media services collected using a plurality of separate data collection modalities into a converged representation of the live event using a single session model language to describe interactions with the converged representation of the event; and
providing the converged representation of the event for user access with one or more client devices.

9. The method of claim 8, further comprising:
collecting user interactions with the live events platform based on the converged representation of the event; and
analyzing the user interactions to determine one or more cues to prompt a performer of the live event with actions to perform during the live event based on the user interactions.

10. The method of claim 9, further comprising:
analyzing the user interactions to produce enriched effects for users accessing the live event with one or more client devices.

11. The method of claim 10, wherein the enriched effects include adding reverb, echo, chorus, augmented-reality filters, and replacing of an audience member's live video with a virtual avatar.

12. The method of claim 11, further comprising:
analyzing the user interactions to determine an effectiveness of the live event over the course of the live event to provide a timeline of user engagement over the course of the event; and
determining preferred pricing, duration and schedules for future similar events based on the determined effectiveness.

13. The method of claim 12, wherein user interactions include interactions an audience member speaking with the artist live, reactions such as virtual hearts and claps, and tipping.

14. The method of claim 8, wherein the collected data includes metadata such as timestamp information and data marking a modality of collection.

15. A non-transitory computer-readable medium comprising instructions for hosting a live event over a live events platform, wherein when the instructions are executed by a computer, the computer is configured for:
broadcasting a live event using a set of media services;
collecting data related to the live event from the set of media services;
interlaying the collected data from the set of media services collected using a plurality of separate data collection modalities into a converged representation of the live event using a single session model language to describe interactions with the converged representation of the event; and
providing the converged representation of the event for user access with one or more client devices.

16. The non-transitory computer-readable medium of claim 15, wherein the instructions further configure the computer for:
collecting user interactions with the live events platform based on the converged representation of the event; and
analyzing the user interactions to determine one or more cues to prompt a performer of the live event with actions to perform during the live event based on the user interactions.

17. The non-transitory computer-readable medium of claim 16, wherein the instructions further configure the computer for:
analyzing the user interactions to produce enriched effects for users accessing the live event with one or more client devices.

18. The non-transitory computer-readable medium of claim 17, wherein the enriched effects include adding reverb, echo, chorus, augmented-reality filters, and replacing of an audience member's live video with a virtual avatar.

19. The non-transitory computer-readable medium of claim 18, wherein the instructions further configure the computer for:
analyzing the user interactions to determine an effectiveness of the live event over the course of the live event to provide a timeline of user engagement over the course of the event; and
determining preferred pricing, duration and schedules for future similar events based on the determined effectiveness.

20. The non-transitory computer-readable medium of claim 19, wherein user interactions include interactions an audience member speaking with the artist live, reactions such as virtual hearts and claps, and tipping.
